(19) United States
(12) Patent Application Publication
(10) Pub. No.: US 2013/0031726 A1
(43) Pub. Date: Feb. 7, 2013

(54) ENCASED HOURGLASS COILS AND MATTRESS CORES

(71) Applicant: Larry K. DEMOSS, Greensboro, NC (US)

(72) Inventor: Larry K. DEMOSS, Greensboro, NC (US)

(73) Assignee: Sealy Technology, LLC, Trinity, NC (US)

(21) Appl. No.: 13/578,750

(22) Filed: Aug. 13, 2012

Related U.S. Application Data
(63) Continuation of application No. PCT/US2012/021681, filed on Jan. 18, 2012.
(60) Provisional application No. 61/435,062, filed on Jan. 21, 2011.

(51) Int. Cl. A47C 23/04; F16F 1/08

(52) U.S. Cl. 5/720; 267/180

(57) ABSTRACT

Encased hourglass coils and encased hourglass coil mattress cores have steel wire coils with an hourglass profile encapsulated in a sheet material enclosure, package, casing, housing, containment or encapsulation, wherein coils are enclosed within an enclosure made of fabric, non-woven, or other material which encapsulates each individual coil spring and serves to maintain multiple coil springs in an array or alignment in a mattress core. The hourglass configurations of the coils, wherein at least one helical convolution of the coil body located between the coil ends has a diameter which is less than every other convolution of the coil body, provides a mattress core which has a relatively lower spring rate upon initial compression and a higher spring rate at higher compression loads.

### RELATED APPLICATIONS

This application claims priority to International Patent Application No. PCT/US2012/021681 filed on Jan. 18, 2012, which claims priority to U.S. Provisional Patent Application Ser. No. 61/435,062, filed on Jan. 21, 2011, each of which are incorporated herein by reference in their entirety.

### FIELD OF THE INVENTION

The present invention is in the general field of reflexive support structures such as mattresses, and more specifically in the field of individual spring components and spring assemblies which are internal to reflexive support structures.

### BACKGROUND OF THE INVENTION

Mattress innersprings, made of matrices or arrays of a plurality of wire form springs or coils, whether laced together as an “innerspring” or contained or encased in individual fabric or flexible material enclosures which are sewn, welded or sonic welded or glued together (also known as “Marshall coils”), have long been used as the spring core of a mattress. Innersprings made of formed steel wire are mass produced by machinery which forms the coils from steel wire stock and interconnects or laces the coils together in the matrix array. With such machinery, design attributes of innersprings can be selected and modified, from the gauge of the wire, the coil design or combination of designs, coil orientation relative to adjacent coils in the matrix array, and the manner of interconnection or lacing of the coils. Different configurations of wire form coils can be used in the fabric enclosures to create different types of spring cores. Fabric enclosed coils have been made with softer spring rate coils which rely on the enclosures to maintain alignment. All wire innersprings on the other hand tend to be stiffer and higher spring rate and must maintain alignment (and avoid adjacent spring contact) without the benefit of individual coil enclosures.

### SUMMARY OF THE INVENTION

The present invention provides a new type of encased coil and encased coil mattress core which utilizes a steel wire coil with an hourglass profile to create a reflexive enclosed coil core with novel spring and support characteristics. The encased hourglass coils of the present invention are encapsulated in a material enclosure, package, casing, housing, containment or encapsulation, for example in the manner of a Marshall type coil, wherein coils are enclosed within an enclosure made of fabric, non-woven, or other material which encapsulates each individual coil spring and serves to maintain multiple coil springs in an array or alignment in a mattress core. The hourglass configuration of the coil, wherein at least one helical convolution of the coil body located between the coil ends has a diameter which is less than every other convolution of the coil body, provides an encased coil and mattress core which has a relatively lower spring rate upon initial compression and a higher spring rate at higher compression loads. The relative diameter and pitch dimensions of the coil body are designed to provide encased coils and a mattress core which has at least two distinct spring rates and a gradual transition between the spring rates, and inherent axial stability.

### DESCRIPTION OF THE DRAWINGS

FIG. 1 is a perspective view of an encased hourglass coil of the present disclosure;

FIG. 2 is an elevation of an encased hourglass coil of the present disclosure;

FIG. 3 is an end view of an encased hourglass coil of the present disclosure;

FIG. 4 is a perspective view of a portion of a spring core made with a plurality of encased hourglass coils of the present disclosure;

FIG. 5 is an elevation of an alternate embodiment of an encased hourglass coil of the present disclosure, and

FIG. 6 is an elevation of an alternate embodiment of an encased hourglass coil of the present disclosure.

### DETAILED DESCRIPTION OF PREFERRED AND ALTERNATE EMBODIMENTS

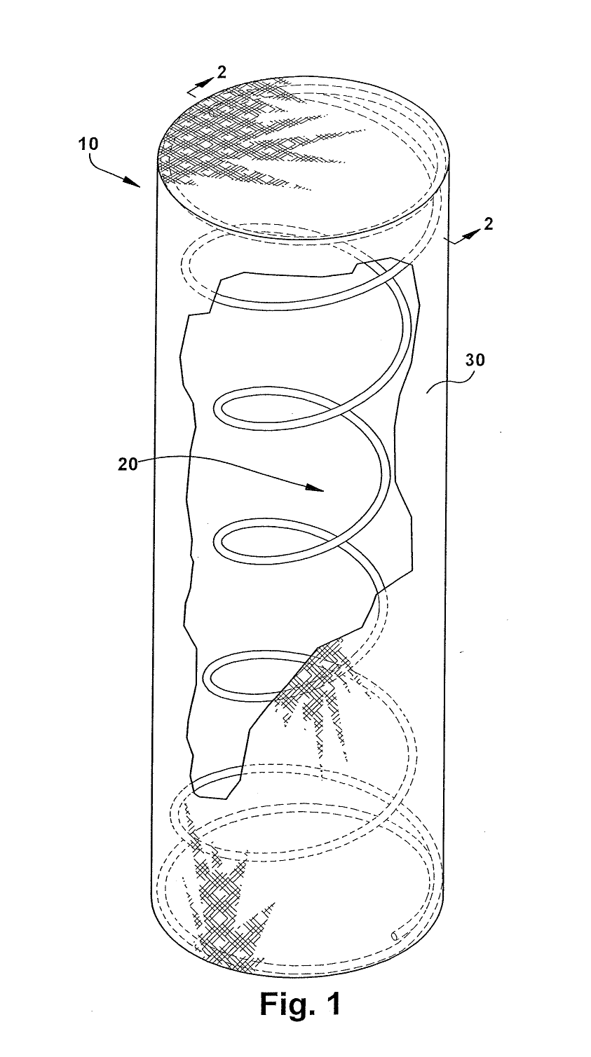

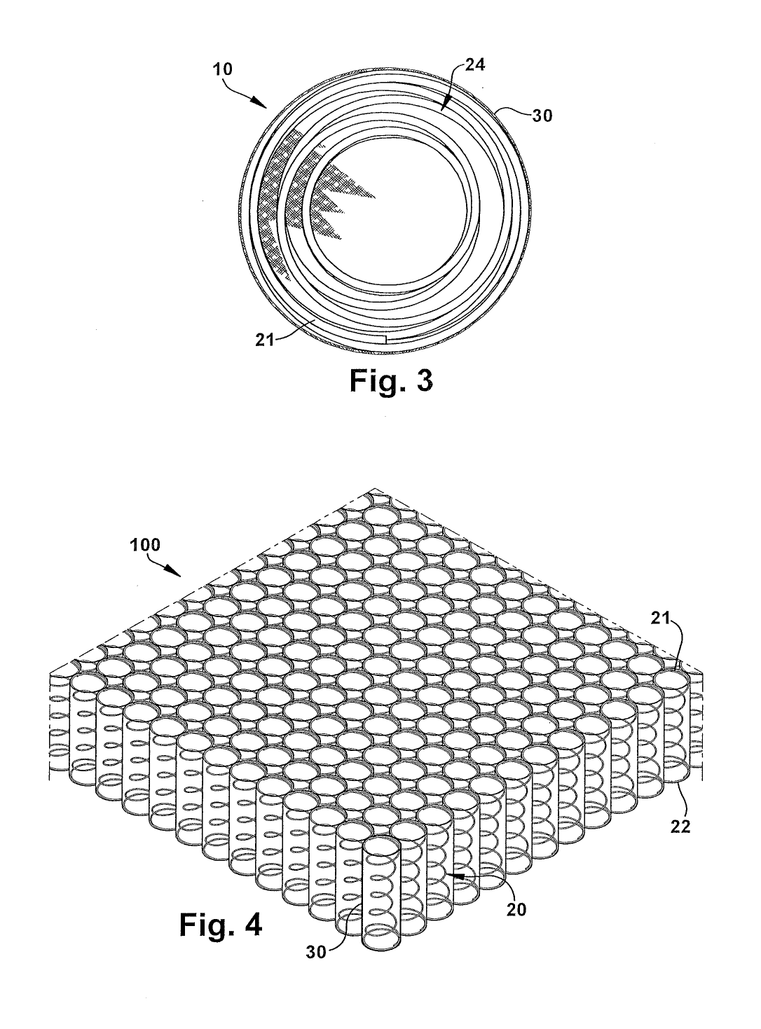

FIGS. 1-4 illustrate a preferred embodiment of an encased hourglass coil, indicated generally at 10, and a spring core 100 (shown in FIG. 4) of the present disclosure. The spring core 100 can be used as the core for a mattress or any other support structure such as seating or furniture where the spring support properties are desired. When used as the core of a mattress, a matrix of encased coils 10 is formed, for example by a series or chain of coils which are separately encased in sheet material which is fused, glued or sewn together as known in the art. The mattress core 100 is then surrounded by various combinations of padding and material such as upholstery to form a mattress. The encased hourglass coil 10 includes coil 20 and an enclosure 30 which is formed from a flexible sheet material such as non-woven fiber material in sheet form or woven fabric. The enclosure 30 is shown in FIGS. 1-3 as a single enclosure or tube of material which encases the coil 20, however it is understood that multiple enclosures 30 can be made in series from continuous adjoined strips of material which are fused or sewn together between adjacent coils and/or at the ends of the coils 20, as well known in the art and described in detail in prior patents.

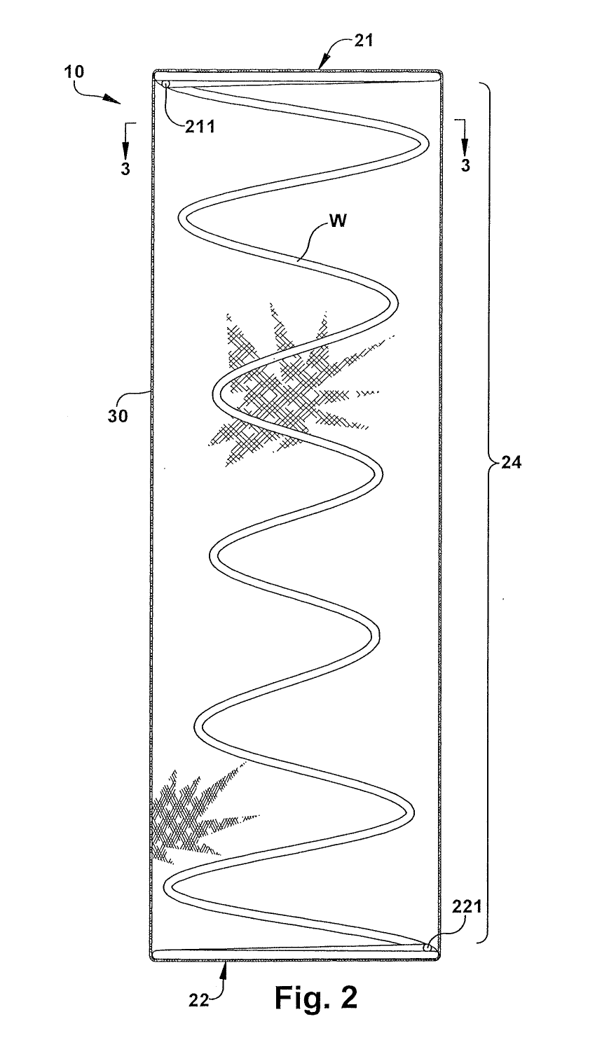

The general configuration of the coil 20, as shown in FIG. 2, includes first and second coil ends 21 and 22 the orientation of which is interchangeable and with corresponding terminal ends 211 and 221, and a coil body 24 between the coil ends 21 and 22, the coil body formed by a plurality of helical turns or convolutions of coil wire W, which may be for example HGC 560-7.5 T, 13 ¾ gauge type steel wire.

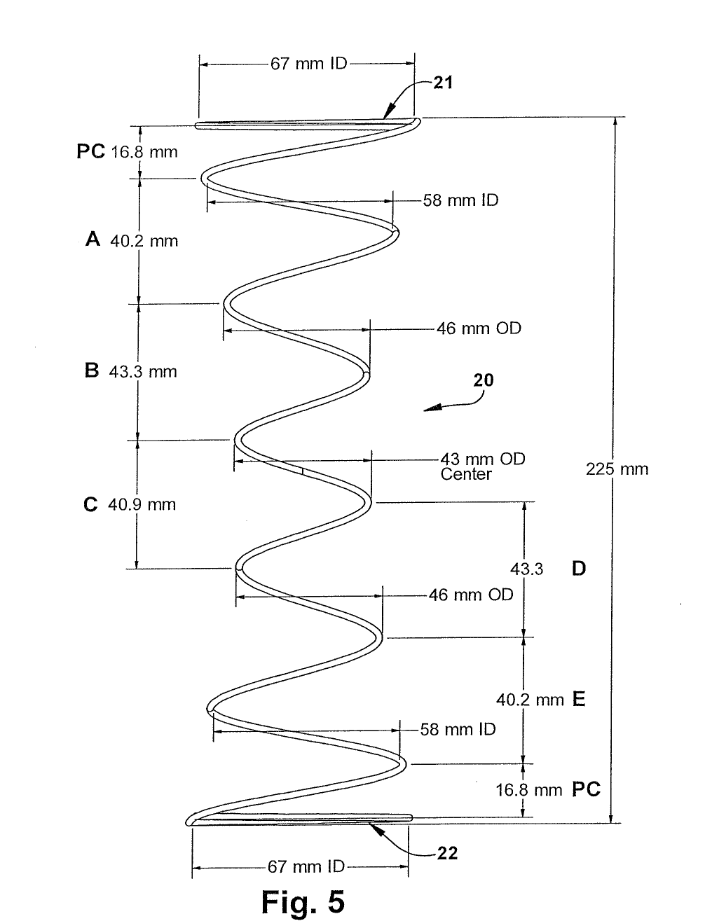

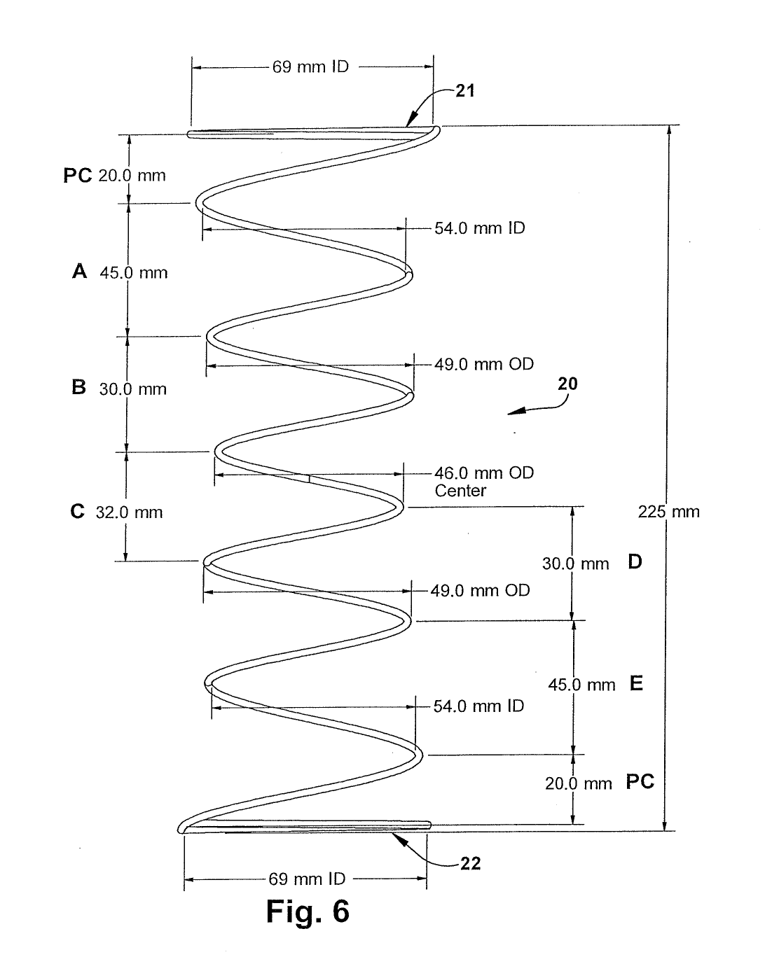

The plurality of helical turns or convolutions of wire W of the coil body 24 are further illustrated in FIGS. 5 and 6, wherein one convolution is measured as one 180 degree helical path of the wire, e.g. from a point on a first side of the coil body to the opposite side and returning to the first side, such as sections A-E in FIG. 5, and sections A-E in FIG. 6. As shown in FIGS. 5 and 6, the convolutions A-E can be measured from any starting point on the coil body. There may be half or partial convolutions PC between the coil ends 21, 22 and the coil body 24. Each of the convolutions of the coil body has a vertical dimension, also referred to as “pitch”, and a diameter which can be measured as inner diameter (ID) or outer diameter (OD). The dimensions as noted on FIGS. 5 and 6 are representative of certain embodiments of the encased hourglass coils of the disclosure and the disclosure is not limited to those particular dimensions or the particular combinations of dimensions. For example, in FIG. 5, an alternate embodiment of the coil has convolutions in the coil body 24 between the coil ends 21, 22 which are of a lesser diameter than convolutions which are closer to the coil ends 21, 22. A diameter of the coil body 24 being least at the middle of the coil body, equidistant from the coil ends, produces an hourglass coil configuration. The pitch of the convolutions (vertical extent) may be variable as indicated, with for example a relatively smaller pitch convolution in an intermediate or middle region of the coil body, relatively larger pitch convolution in each half of the coil body, and a relatively smaller or smallest convolution closest to each coil end. In general, relatively larger convolution pitch dimensions result in higher spring rates. Relatively larger convolution diameters result in lower spring rates, greater support area, and less lateral stability. The overall coil height as measured from coil end 21 to coil end 22 and indicated on FIGS. 5 and 6, in an un-compressed state or in other words not encased or under any compression by an encasement, is also a factor in the aggregate spring rate, support characteristics, stability and performance of the coil and of an innerspring made up of the coils. The particular combinations of dimensions shown in FIGS. 5 and 6 produce coils which have relatively higher spring rates (softer feel) proximate to the coil ends 21, 22 which then gradually transitions to a higher spring rate (firmer feel) as the coil is compressed. The hourglass configuration of the coil body 24 substantially increases the firmness of relatively higher spring rate of the coil and innerspring under a compression load but also retains the relatively lower spring rate and soft initial feel proximate to the coil ends under initial or low compression. The particular combinations of the denoted pitch and diameter dimensions of the convolutions of the coil body, overall coil height, and coil end diameters are specifically designed to have the coil and innerspring provide the firmness of relatively higher spring rate under a compression load and to also have the relatively lower spring rate and soft initial feel proximate to the coil ends under initial or low compression, and to provide the coil and innerspring with lateral stability. Inherent lateral stability of the coil under load or compression without relying completely on the enclosure to maintain alignment provides greater stability to the innerspring overall. As also noted on FIGS. 5 and 6, one or more of the convolutions located at the midpoint of the coil body (between coil ends 21 and 22) are preferably of a lesser pitch dimension relative to the other convolutions of the coil body. This configuration promotes and enables the ability to roll pack bale a mattress core made of the encased coils.

As a representative example of coil height dimensions, a raw uncompressed coil prior to encapsulation or enclosure can have a total height in a range 8.0 inches to 8.5 inches. The coil can then be pre-compressed to an approximate height of 7.5 inches, which may be for example the height of the enclosure 30. Under compression, at 1.10 lbs. +/−0.10 the coil height is 6.25 inches, at 1.20 lbs. +/−0.05 the coil height is 5.25 inches, at 1.30 lbs. +/−0.10 the coil height is 4.25 inches, and at 1.55 lbs. +/−0.10 the coil height it 3.25 inches. This demonstrates that the compression force or spring rate of the coil and mattress core increases with the extent of compression of the encased coils to provide the desired variable spring force and support. For alternate embodiments of the coil which have different total height dimensions the vertical extent of the enclosure 30 can be altered accordingly. Alternatively, a greater or lesser degree of compression can be imparted to the coil by the enclosure 30 which will accordingly alter the spring rates and feel of the encased coil and mattress core.

1. A mattress core comprised of a plurality of encased wire coils, each coil having a coil body formed by a plurality of helical convolutions of wire and a coil end at first and second axial ends of the coil body, and wherein at least one helical convolution of the coil body located between the coil ends has a diameter which is less than every other convolution of the coil body, whereby each of the encased wire coils of the mattress core has a relatively lower spring rate upon initial compression and a higher spring rate at higher compression loads.

2. The mattress core of claim 1, wherein the at least one helical convolution of the coil body is equidistant from the first and second axial ends of the coil body.

3. The mattress core of claim 1, wherein the diameter of the plurality of helical convolutions decreases as they approach a middle of the coil body.

4. The mattress core of claim 1, wherein the convolutions located at a midpoint of the coil body have a lesser pitch dimension than the pitch dimension of the other convolutions of the coil body.

5. The mattress core of claim 1, wherein each of the plurality of wire coils has a raw uncompressed coil height dimension of between approximately 8.0 inches and approximately 8.5 inches, prior to encasement.

6. The mattress core of claim 1, wherein each of the plurality of wire coils has a pre-compressed height of approximately 7.5 inches, after encasement.

7. The mattress core of claim 1, wherein each of the plurality of encased wire coils, at a compression of approximately 1.10 lbs., has a coil height of 6.25 inches.

8. The mattress core of claim 1, wherein each of the plurality of encased wire coils, at a compression of approximately 1.20 lbs., has a coil height of 5.25 inches.

9. The mattress core of claim 1, wherein each of the plurality of encased wire coils, at a compression of approximately 1.30 lbs., has a coil height of approximately 4.25 inches.

10. The mattress core of claim 1, wherein each of the plurality of encased wire coils, at a compression of approximately 1.55 lbs., has a coil height of approximately 3.25 inches.

11. A wire coil having a plurality of helical turns extending between a first terminal convolution and a second terminal convolution, the helical turn which is equidistant from the first terminal convolution and the second terminal convolution having the smallest diameter, wherein the spring rate of the wire coil increases with the extent of compression applied thereto.

12. The wire coil of claim 11, wherein the height of the coil is between approximately 8.0 inches and approximately 8.5 inches.

13. The wire coil of claim 11, wherein the diameter of the plurality of helical turns decreases between the first terminal convolution and a center convolution.

14. The wire coil of claim 11, wherein the diameter of the plurality of helical turns increases between a center convolution and the second terminal convolution.

15. The wire coil of claim 11, wherein the pitch between a convolution located at a midpoint of the wire coil and each adjacent convolution is less than the pitch between all other convolutions.

16. The wire coil of claim 11, wherein the coil is encased in fabric.

17. The wire coil of claim 16, wherein the height of the coil encased in fabric is approximately 7.5 inches.

18. The wire coil of claim 17, wherein the height of the coil is approximately 6.25 inches under compression of approximately 1.10 lbs.

19. The wire coil of claim 17, wherein the height of the coil is approximately 5.25 inches under compression of approximately 1.20 lbs.

20. The wire coil of claim 17, wherein the height of the coil is approximately 4.25 inches under compression of approximately 1.30 lbs.
